(19) United States
(12) Patent Application Publication
(10) Pub. No.: US 2007/0153111 A1
(43) Pub. Date: Jul. 5, 2007

(54) Imaging device and method for displaying shooting mode

(75) Inventor: Yosuke Kato, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/649,255

(22) Filed: Jan. 4, 2007

(30) Foreign Application Priority Data
Jan. 5, 2006 (JP) 2006-000872

(51) Int. Cl. H04N 5/222

(52) U.S. Cl. 348/333.11

(57) ABSTRACT

Upon pressing a power switch, a power supply of an electronic camera is turned on. A subject image is taken by a camera unit and is converted into image data for which a corrector performs image processing. The processed image data is displayed on a monitor as a through image in real time. A function for displaying a recommended shooting mode is turned on, and a shooting angle is determined while the through image is viewed. Upon half depression of a shutter button, the through image is sent to an image analyzer to estimate a shooting scene. On the basis of the estimated shooting scene, a mode judging unit judges the shooting mode to be recommended. The monitor displays the recommended shooting mode. The displayed shooting mode is selected and determined to set the recommended shooting mode. Regular shooting is performed upon full depression of the shutter button.

### FIELD OF THE INVENTION

The present invention relates to an imaging device capable of changing shooting modes having different shooting conditions, and further relates to a method for displaying a recommended shooting mode.

### BACKGROUND OF THE INVENTION

Electronic cameras provided with shooting modes of different shooting conditions are widely used. In this kind of the electronic camera, shooting is adapted to be performed for various shooting scenes under the proper shooting conditions (see Japanese Patent Laid-Open Publication No. 2005-175684). It is possible to manually change the shooting mode by operating a mode selector disposed on a camera body, for example. The shooting modes include a person shooting mode, a scene shooting mode, a night-view shooting mode and so forth. Under the respective shooting modes, proper shooting conditions are set in accordance with a shooting scene.

Besides the shooting modes corresponding to the shooting scenes, many electronic cameras are provided with an automatic mode for automatically changing the shooting conditions. Under the automatic mode, the camera automatically judges the shooting scene on the basis of photometric information and so forth, and the shooting conditions corresponding thereto are set. Under the automatic mode, however, although the shooting conditions are changed, these conditions are not greatly changed from the normal conditions in comparison with the case in that the mode is manually selected. Thus, proper shooting conditions corresponding to the shooting scene are often set by manually selecting the mode rather than by the automatic mode.

However, it is difficult for many general users to sufficiently understand shooting properties of the respective shooting mode. In addition, operations are complicated. For these reasons, manual mode selection is likely to be skirted. But then, such as mentioned above, the manual mode has utility values which are not obtained under the automatic mode. It is desired to provide methods in that the manual mode is easily utilized by a user.

### SUMMARY OF THE INVENTION

In view of the foregoing, it is a primary object of the present invention to provide an imaging device in which a manual mode is easily utilized.

It is a second object of the present invention to provide a shooting-mode displaying method for the above-mentioned imaging device.

In order to achieve the above and other objects, the imaging device according to the present invention comprises a scene distinction unit, a shooting-mode judgment unit and a display. The imaging device includes an image sensor for taking a subject to obtain a shooting image, and has a plurality of shooting modes of which shooting conditions are different in performing regular shooting with the image sensor. Regular-image data obtained by the regular shooting is saved in a memory. The scene distinction unit distinguishes a scene of the shooting image by analyzing pre-image data obtained by the image sensor before the regular shooting. The shooting-mode judgment unit judges at least one of the shooting modes as the shooting mode to be recommended on the basis of a distinction result of the scene distinction unit. The display shows the recommended shooting mode judged by the shooting-mode judgment unit.

It is preferable that sorts of the shooting modes are determined in accordance with at least one of a kind of the main subject including a person and scenery, shooting environment, and a state of contrast.

It is preferable that the recommended shooting mode is determined and the regular shooting is performed by fully depressing a shutter button when the display shows the sole recommended shooting mode. In this case, a shooting operation is simplified.

It is preferable to comprise a selection member for selecting one of the recommended shooting modes shown on the display. In virtue of the selection member, shooting intention of a user is reflected.

It is preferable that the display shows a through image, which is obtained by the image sensor during framing, in real time without saving the through image in the memory.

It is preferable that data of the through image is used as the pre-image data. By doing so, a time-lag of a shooting time is reduced.

It is preferable to comprise an instruction member for instructing the analysis of the pre-image data. The instruction member may be the shutter button. In this case, the analysis of the pre-image data is instructed by depressing the shutter button halfway. Alternatively, the instruction member may be a microphone used for inputting a voice. In this case, the analysis of the pre-image data is instructed by inputting a predetermined voice into the microphone.

It is preferable to comprise a saving-format selector for changing a saving format of the regular-image data in accordance with the distinction result of the scene distinction unit. The regular-image data is saved in the memory in the saving format selected by the saving-format selector. The saving-format selector may select either one of a first format, in which image processing including data compression processing is performed for the regular-image data to save the processed image data, and a second format, in which saving is carried out without performing the image processing for the regular-image data. In this case, the regular-image data is saved in the first format without regard to a selection result of the saving-format selector when a space of the memory is equal to or less than a predetermined amount.

The shooting-mode displaying method according to the present invention comprises the steps of distinguishing a scene of the shooting image by analyzing the pre-image data, and judging at least one of the shooting modes as the shooting mode to be recommended on the basis of the distinguished scene. The shooting-mode displaying method further comprises the step of displaying the shooting mode judged as the recommended shooting mode.

According to the present invention, the manual mode is easily used and it is possible to set the optimum shooting conditions corresponding to the shooting scene. Furthermore, it is possible to take a picture on the optimum shooting conditions corresponding to the shooting scene.

### BRIEF DESCRIPTION OF THE DRAWINGS

FIG. 1 is a block diagram showing an electrical structure of an electronic camera according to the present invention;

FIG. 2 is an illustration of a monitor on which a recommended shooting mode is displayed;

FIG. 3 is a flowchart showing a shooting procedure; and

FIG. 4 is a flowchart showing a saving procedure for image data.

### DESCRIPTION OF THE PREFERRED EMBODIMENTS

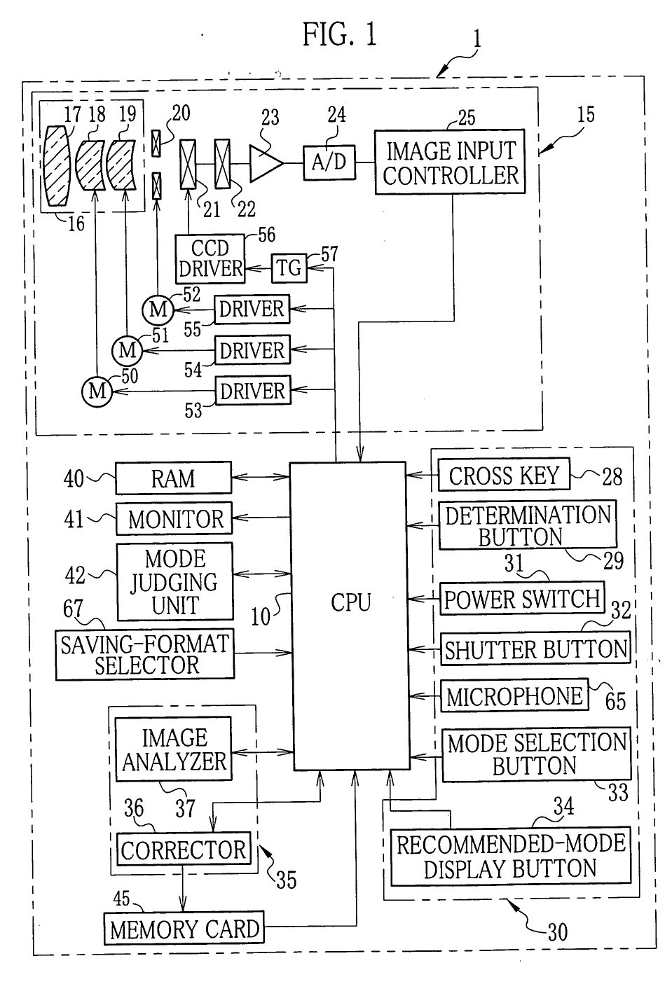

FIG. 1 is a block diagram showing an electrical structure of an electronic camera 1 according to the present invention. In the electronic camera 1, various circuits are integrally controlled by a CPU 10 connected to a camera unit 15, an operating unit 30, an image processor 35, a RAM 40, a monitor 41 and a mode judging unit 42.

The camera unit 15 comprises a taking lens 16, a stop mechanism 20, a CCD image sensor (imaging member) 21, a correlation double sampling circuit (CDS) 22, and an amplifier (AMP) 23, an A/D converter 24, an image input controller 25, a zoom-lens driving motor 50, a focus-lens driving motor 51, a stop driving motor 52, drivers 53, 54 and 55, a CCD driver 56, and a timing generator 57. The taking lens 16 comprises a fixed lens 17, a zoom lens 18 and a focus lens 19. The zoom lens 18 and the focus lens 19 are respectively moved by the zoom-lens driving motor 50 and the focus-lens driving motor 51. Meanwhile, the stop mechanism 20 is disposed in front of the CCD image sensor 21. As to the stop mechanism 20, an f-number is changed by the stop driving motor 52 so that an amount of light to enter the CCD image sensor is regulated.

The zoom-lens driving motor 50, the focus-lens driving motor 51 and the stop driving motor 52 are connected to the drivers 53, 54 and 55 respectively. Via these drivers 53 to 55, the CPU 10 controls actuation of the respective motors 50, 51 and 52.

The CCD driver 56 is connected to the CCD image sensor 21. The CCD driver 56 inputs a vertical drive signal and a horizontal drive signal into the CCD image sensor 21 in accordance with a clock pulse, which is inputted from the timing generator 57, to drive the CCD image sensor 21. The timing generator 57 is connected to the CPU 10 by which the timing generator 57 is controlled and the clock pulse is generated to drive the CCD image sensor 21.

The correlation double sampling circuit (CDS) 22 and the amplifier (AMP) 23 are connected to the CCD image sensor 21. By these components, noise is removed and amplification is performed for an image signal outputted from the CCD image sensor 21.

After removing the noise and performing the amplification, the image signal is converted by the A/D converter 24 from an analog signal into a digital signal. The converted digital signal is outputted as image data to the image input controller 25.

The image input controller 25 stores the image data, which is outputted from the A/D converter 24, in the RAM 40.

The image processor 35 comprises a corrector 36 and an image analyzer 37. The corrector 36 is connected to the CPU 10 and performs various image processes of gradation conversion, white balance, gamma correction and so force for the image data temporarily stored in the RAM 40. In addition, the corrector 36 performs YC conversion process and so forth for the image data. The processed image data is displayed on the monitor (display) 41 as a through image in real time.

For example, the through image displayed in real time is obtained by the CCD image sensor 21 at a frame rate of about thirty frames per second. Besides the display of the through image, the monitor 41 displays image data saved in a memory card (external memory) 45 and displays setting of various functions as well.

The operating unit 30 comprises a cross key 28, a determination button 29, a power switch 31, a shutter button 32, a mode selection button 33 and a recommended-mode display button 34, which are respectively connected to the CPU 10. The cross key 28 is used for selecting various kinds of setting. The determination button 29 is used for determining the selected setting. The power switch 31 is capable of turning on and off a power source of the electronic camera 1. The shutter button 32 has a mechanical structure in that the shutter button 32 is depressed in two steps of half depression shallowly depressed and full depression deeply depressed.

The mode selection button 33 is capable of changing a plurality of shooting modes having different shooting conditions concerning a stop, a shutter speed (charge storage time), ISO sensitivity, an exposure value and so forth. The shooting modes are broadly classified into an automatic mode and a manual mode. The automatic mode is the shooting mode in which photometry of a subject is performed to obtain a photometric value and a shooting scene is automatically judged on the basis of the photometric value to change the shooting conditions. Under the automatic mode, the photometry is started and the shooting conditions are automatically set upon the half depression of the shutter button 32 and shooting is performed on the automatically set shooting conditions when the shutter button 32 has been fully depressed.

As to the manual mode, there are a person shooting mode in which shooting conditions suitable for a person are set, a scene shooting mode in which shooting conditions suitable for a scene are set, and a nighttime shooting mode in which shooting conditions suitable for night shooting are set. The respective manual modes are adapted to be selected in accordance with the operation of the mode selection button 33 performed by a user.

Meanwhile, the electronic camera 1 is provided with the display button 34 for the recommended shooting mode. The electronic camera 1 has a function for displaying the recommended shooting mode. The display button 34 is an operational member for turning on and off the display function of the recommended shooting mode. In this regard, the recommended shooting mode means the shooting mode which is one of the manual modes and is judged by the electronic camera 1 as the optimum shooting mode corresponding to the shooting scene. When the shooting mode is set to any one of the manual modes and when the display function of the recommended shooting mode is turned on, the electronic camera 1 analyzes the through image obtained upon the half depression of the shutter button 32 to estimate the shooting scene. And then, the electronic camera 1 judges the recommended shooting mode.

The image analyzer (for distinguishing a scene) 37 is connected to the CPU 10 and analyzes the through image to estimate the shooting scene. Incidentally, as to a method for estimating the shooting scene, it is preferable that plural object areas are extracted from image data and a sort of each area is judged such as described in Japanese Patent Laid-Open Publication No. 2004-62605, for instance. Concretely, the areas occupied by a person, the sky, the sea, a building and other objects are extracted from the image every sort of the object to judge this sort.

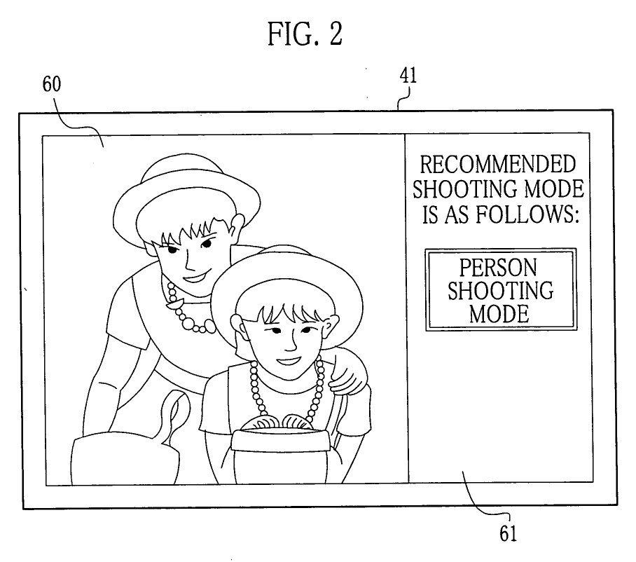

On the basis of the shooting scene estimated by the image analyzer 37, the mode judging unit 42 (for judging the shooting mode to be recommended) nominates at least one of the shooting modes suitable for the shooting conditions. After nominating the shooting mode, the monitor 41 (for displaying the recommended shooting mode) is divided into a through-image display area 60 and a recommended shooting-mode display area 61 as shown in FIG. 2 such that the through image is displayed together with the recommended shooting mode.

One of the recommended shooting modes displayed on the monitor 41 is selected by operating the cross key (selector member) 28. The selected shooting mode is determined by the determination button 29. Upon this, the recommended shooting mode is set. For example, even when the scene shooting mode is set by the mode selection button 33, the scene shooting mode is changed to the person shooting mode upon determining the person shooting mode, which is displayed as the recommended shooting mode, by the determination button 29. After that, by fully depressing the shutter button 32, regular shooting is performed on the proper shooting conditions corresponding to the shooting scene.

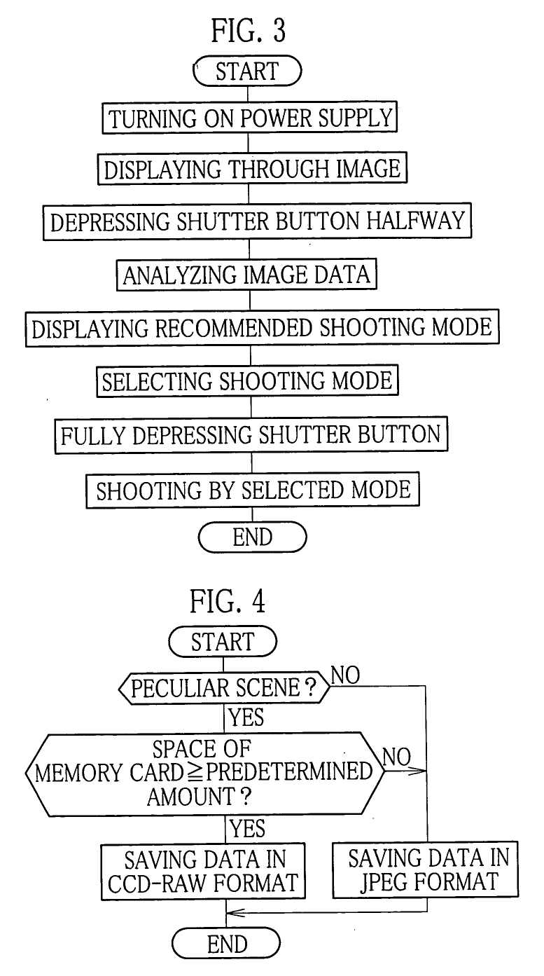

An operation of the above structure is described below with reference to a flowchart shown in FIG. 3. The power switch 31 is pressed to turn on the power source of the electronic camera 1. A subject image, light of which is guided by the fixed lens 17, is taken by the camera unit 15 and is converted into the image data. The corrector 36 performs image processing for the image data. The processed image data is displayed on the monitor 41 as the through image in real time.

When the display function of the recommended shooting mode is turned off, the shooting mode is selected by the mode selection button 33 and shooting is performed under the selected shooting mode by fully depressing the shutter button 32.

When the display function of the recommended shooting mode is turned on, a shooting angle is determined and the shutter button 32 is depressed halfway while the through image displayed on the monitor 41 is viewed. Upon the half depression of the shutter button 32, the through image displayed on the monitor 41 is sent to the image analyzer 37 to estimate the shooting scene. On the basis of the estimated shooting scene, the mode judging unit 42 nominates the shooting mode to be recommended, and the monitor 41 displays the recommended shooting mode (see FIG. 2). The shooting mode displayed on the monitor 41 is selected and determined by the cross key 28 and the determination button 29 to set the recommended shooting mode. After that, the shutter button 32 is fully depressed to perform the regular shooting on the proper shooting conditions corresponding to the shooting scene. Incidentally, when the monitor 41 displays the sole recommended shooting mode, selecting and determining the recommended shooting mode may be performed by the full depression of the shutter button 32. In this case, the regular shooting is simultaneously performed at that time.

In the above embodiment, the electronic camera 1 is described as the imaging device. However, the imaging device may be a camera-equipped cell-phone, a PDA and so forth.

In the above embodiment, the through image is used as pre-image data taken before the regular shooting, and the shooting scene is estimated by analyzing this image data. However, pre-shooting may be performed separately from the through image used for the display of the monitor 41, and image data obtained by the pre-shooting may be used as the pre-image data to estimate the shooting scene.

In the above embodiment, the shooting scene is estimated when the shutter button 32 has been depressed halfway. However, this is not exclusive. For example, another button may be provided and the shooting scene may be estimated by operating this button. Alternatively, a microphone 65 for inputting a voice may be provided such as shown in FIG. 1, and the shooting scene may be estimated by inputting a predetermined voice into the microphone 65.

In the above embodiment, are particularized the person shooting mode, the scene shooting mode and the nighttime shooting mode as the manual modes. However, theses shooting modes are mere examples. Other various shooting modes may be considered.

In the above embodiment, the monitor 41 on which the through image is displayed is also used for displaying the recommended shooting mode. However, this is not exclusive. Another monitor for displaying the recommended shooting mode may be provided.

In the above embodiment, the shooting scene is estimated by analyzing the image to judge and display the recommended shooting mode. It is considered that estimating the shooting scene by the image analysis may be usefully utilized besides displaying the recommended shooting mode. For instance, a format for saving the shooting-image data of the electronic camera may be changed by estimating the shooting scene. Regarding the known saving format of the shooting-image data, there are two kinds of the formats, for example, one of which is a processed-data saving format (first format) and the other of which is a raw-data saving format (second format). In the first format, inherent image processing of the electronic camera and data compression processing are performed before saving for raw image data produced by converting the analog signal, which is outputted from the CCD image sensor, into the digital signal. In the second format, the data is saved without performing the inherent image processing of the electronic camera. For example, the first and second formats are adapted to be selected by a saving-format selector 67 shown in FIG. 1.

The processed-data saving format is called as JPEG format derived from a name of an image file format. The raw-data saving format is called as RAW format. As to the JPEG format, since finishing of a picture depends on the image processing of the electronic camera to some extent, degree of freedom of image processing is low. However, it is possible to reduce a data size of the image data. As to the RAW format, since the image data is raw, degree of freedom of image processing is high and a user is likely to have desired finishing. However, the data size of the image data is large.

In general, the saving formats are adapted to be manually changed and selection thereof is carried out by a user. However, there is a case in that image processing fails if the inherent image processing of the electronic camera is performed for some shooting scenes. Once the image processing fails, it is difficult to restore the image data. With respect to the shooting scenes for which the image processing fails, there are peculiar scenes of undersea shooting, sunset shooting, high contrast shooting and so forth. In this regards, it is useful that the data saving formats are automatically changed by utilizing the function for estimating the shooting scene.

When the saving format is automatically changed in accordance with the shooting scene, it is preferable to check a space of the memory card because the data size of the raw image data of the RAW format is large, and it is preferable that the RAW format is selected only when there is the space to some extent.

Selecting the saving format and checking the space of the memory card are performed by the image analyzer 37 and the CPU 10, for example. As shown in a flowchart of FIG. 4, when the shutter button 32 has been depressed halfway, the image analyzer 37 analyzes the through image of the pre-shooting data to judge whether the shooting scene is the peculiar scene or not. On the basis of a judgment result of the image analyzer 37, the CPU 10 selects one of the saving formats. When the selected format is the RAW format, the CPU 10 further checks the space of the memory card 45. If the space is equal to or more than a predetermined amount, saving is performed in the selected RAW format. If the space is less than the predetermined amount, saving is performed in the JPEG format.

In the above embodiment, the saving format is automatically changed in accordance with the judged shooting scene. However, the recommended saving format may be displayed on the monitor 41 and so forth after judgment of the shooting scene. In this case, the recommended saving format is proposed to the user and is ultimately decided by the user.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An imaging device including an image sensor for taking a subject to obtain a shooting image, said imaging device having a plurality of shooting modes of which shooting conditions are different in performing regular shooting with said image sensor, and regular-image data obtained by said regular shooting being saved in a memory, said imaging device comprising:
a scene distinction unit for distinguishing a scene of said shooting image by analyzing pre-image data obtained by said image sensor before said regular shooting;
a shooting-mode judgment unit for judging at least one of said shooting modes as the shooting mode to be recommended on the basis of a distinction result of said scene distinction unit; and
a display for showing the recommended shooting mode judged by said shooting-mode judgment unit.

2. The imaging device according to claim 1, wherein sorts of said shooting modes are determined in accordance with at least one of a kind of the main subject including a person and scenery, shooting environment, and a state of contrast.

3. The imaging device according to claim 1, further comprising:
a shutter button for performing said regular shooting.

4. The imaging device according to claim 3, wherein the recommended shooting mode is determined and the regular shooting is performed by fully depressing said shutter button when said display shows the sole recommended shooting mode.

5. The imaging device according to claim 1, further comprising:
a selection member for selecting one of the recommended shooting modes shown on said display.

6. The imaging device according to claim 5, further comprising:
a determination button for determining the recommended shooting mode selected by said selection member.

7. The imaging device according to claim 1, wherein said display shows a through image, which is obtained by said image sensor during framing, in real time without saving the through image in said memory.

8. The imaging device according to claim 7, wherein data of said through image is used as said pre-image data.

9. The imaging device according to claim 8, further comprising:
an instruction member for instructing analysis of said pre-image data.

10. The imaging device according to claim 9, wherein said instruction member is a shutter button used for performing said regular shooting, and the analysis of said pre-image data is instructed by depressing said shutter button halfway.

11. The imaging device according to claim 9, wherein said instruction member is a microphone used for inputting a voice, and the analysis of said pre-image data is instructed by inputting a predetermined voice into said microphone.

12. The imaging device according to claim 1, further comprising:
a saving-format selector for changing a saving format of said regular-image data in accordance with the distinction result of said scene distinction unit, said regular-image data being saved in said memory in the saving format selected by said saving-format selector.

13. The imaging device according to claim 12, wherein said saving-format selector selects either one of a first format, in which image processing including data compression processing is performed for said regular-image data to save the processed image data, and a second format, in which saving is carried out without performing said image processing for said regular-image data.

14. The imaging device according to claim 13, wherein said regular-image data is saved in said first format without regard to a selection result of said saving-format selector when a space of said memory is equal to or less than a predetermined amount.

15. A shooting-mode displaying method for an imaging device including an image sensor for taking a subject to obtain a shooting image, said imaging device having a plurality of shooting modes of which shooting conditions are different in performing regular shooting with said image sensor, said shooting-mode displaying method comprising the steps of:
distinguishing a scene of said shooting image by analyzing pre-image data obtained by said image sensor before said regular shooting;
judging at least one of said shooting modes as the shooting mode to be recommended on the basis of the distinguished scene; and
displaying the shooting mode judged as the recommended shooting mode.

16. The shooting-mode displaying method according to claim 15, wherein the recommended shooting mode is displayed together with a through image obtained by said image sensor during framing before said regular shooting.

17. The shooting-mode displaying method according to claim 16, wherein data of said through image is used as said pre-image data.
